(19) United States
(12) Patent Application Publication
(10) Pub. No.: US 2009/0025229 A1
(43) Pub. Date: Jan. 29, 2009

(54) Dry Shaver with Pivotal Shaving Head

(76) Inventors: Diana Kappes, Eppstein (DE); Joerge Kaiser, Emmendingen (DE); Alexander Kloes, Hotheim (DE); Bernhard Kraus, Braunfels (DE); Andreas Larscheid, Kelkheim (DE); Stefan Rehbein, Frankfurt am Main (DE)

Correspondence Address: FISH & RICHARDSON PC, P.O. BOX 1022, MINNEAPOLIS, MN, 55440-1022, US

(21) Appl. No.: 12/206,041

(22) Filed: Sep. 8, 2008

Related U.S. Application Data
(63) Continuation of application No. PCT/EP2007/001749, filed on Mar. 1, 2007.

(30) Foreign Application Priority Data
Mar. 7, 2006 (DE) 10 2006 010 328.8

(51) Int. Cl. B26B 19/02

(52) U.S. Cl. 30/43.92

(57) ABSTRACT

A dry shaver with a housing features a drive motor and a shaving head connected to the housing for pivotal movement about a pivot axis. The shaving head mounts at least two shaving systems, each comprised of an outer cutter and associated under cutters. The under cutters are adapted to be driven in an oscillatory linear motion relative to the outer cutter. The at least two under cutters are mounted respectively on separate oscillatory elements in the shaving head. The oscillatory elements are each connected to the drive motor via drive elements and are driven in mutually opposite directions.

### CROSS-REFERENCE TO RELATED APPLICATIONS

This application is a continuation of, and claims priority under 35 U.S.C. 120 from, International Application No. PCT/EP2007/001749, filed Mar. 1, 2007, which claims priority to German Application No. 10 2006 010 328.8, filed Mar. 7, 2006. The contents of each of these applications are incorporated herein by reference in their entirety.

### TECHNICAL FIELD

This invention relates to a dry shaver.

### BACKGROUND

A dry shaver is known in the art from DE 36 10 736 C2. The dry shaving apparatus disclosed therein is characterized already by very good adaptability to the contour of skin to be shaved and as such produces excellent shaving results. The known shaver has a drive pin projecting out of the housing and driven in an oscillating movement, which drive pin drives a drive plate arranged on the pivotal shaving head, there being arranged on the drive plate two under cutters which then reciprocate jointly and in the same direction when the drive motor is activated. Without suitable counter-measures, the under cutters oscillating in the same direction would generate disturbing vibrations for the user. Suitable vibration reduction measures, for example using balance weights oscillating in mutually opposite directions, are complex and also require additional space in the pivotal shaving head, whereby the weight of the shaving head is increased.

### SUMMARY

In one aspect, a dry shaver includes a housing, a drive motor arranged in the housing, a driver coupled to the drive motor, and a shaving head. The shaving head is adapted to couple to the housing and is pivotable about an axis defined by the housing. The shaving head includes at least two shaving systems. Each shaving system includes an outer cutter, an oscillator adapted to couple to one of the drivers, and an under cutter coupled to the oscillator. The under cutter is drivable in an oscillatory linear motion relative to the outer cutter. The under cutter of a first one of the shaving systems is drivable in a mutually opposite direction from the under cutter of a second one of the shaving systems.

In some implementations, one drive element driven in a rotary movement is passed out through the housing. The drive element provides for the drive motor to have a rotationally driven drive shaft. The drive shaft has at least two eccentric portions or drivers arranged one behind the other in the axial direction. Also it is conducive to simple construction to arrange for the drive elements to engage directly in portions of the oscillatory elements. Depending on the requirements or restrictions with regard to the space available, it can be an advantage for the drive elements to be connected to the oscillatory elements by means of respective intermediate transmission means. Said transmission means can be constructed, for example, as a connecting rod or, alternatively, as a joint pushrod. A particularly simple constructional design for the transmission of drive energy into the shaving head is for each of the oscillatory elements to have a slotted portion for the direct or indirect coupling of the respective drive element, with the slot extending in a direction transverse to the pivot axis of the shaving head. Advantageously, in this arrangement at least one of the slots is constructed as a through-slot so that, in accordance with a particularly simple embodiment of the invention, the drive elements can be constructed as two eccentric elements arranged one behind the other.

Some implementations provide for two oscillatory elements to be mounted to fit within one another or to be coupled to one another, thereby obviating the need for additional bearing means.

Particularly great freedom of construction and design is possible with regard to the overall geometry and design of the shaving head. For example, a shaving head with two differently sized cutting systems is provided by an embodiment in which the oscillatory elements are driven with different or variously large amplitudes. If, for example, the under cutters of the respective shaving systems have variously large masses, this will result in unwanted vibrations. Said vibrations can balance each other by accordingly coordinated, variously large oscillation amplitudes.

As described herein, it is possible to greatly improve the vibration behavior of a dry shaver with a pivotal shaving head or to compensate for vibrations already directly in the shaving head itself. For example, one embodiment provides for there to be at least two drive elements driven in a translational oscillating movement, with each drive element adapted to be coupled to one of several oscillatory elements. It is thus possible to greatly minimize the space required in the shaving head itself for the arrangement of oscillatory bridges, allowing for a compact design, including a shaving head with a small overall height.

Further objects, features, advantages and application possibilities will become apparent from the subsequent description of the embodiments. It will be understood that any single feature and any combination of single features described or represented by illustration form the subject matter of the present description, and do so independently of their summary in the claims.

### BRIEF DESCRIPTION OF THE DRAWINGS

FIG. 1 is an exploded perspective view of a dry shaver;

FIG. 2 is a sectional view of a dry shaver, taken parallel to the vertical axis and transverse to the pivot axis;

FIG. 3 is a perspective view of an oscillatory bridge arrangement;

FIG. 4 is a view of another embodiment;

FIGS. 5 to 8 are several representations of alternative embodiments; and

FIGS. 9 and 10 are views of another embodiment.

Mutually corresponding component and function parts are assigned like reference characters in the following.

### DETAILED DESCRIPTION

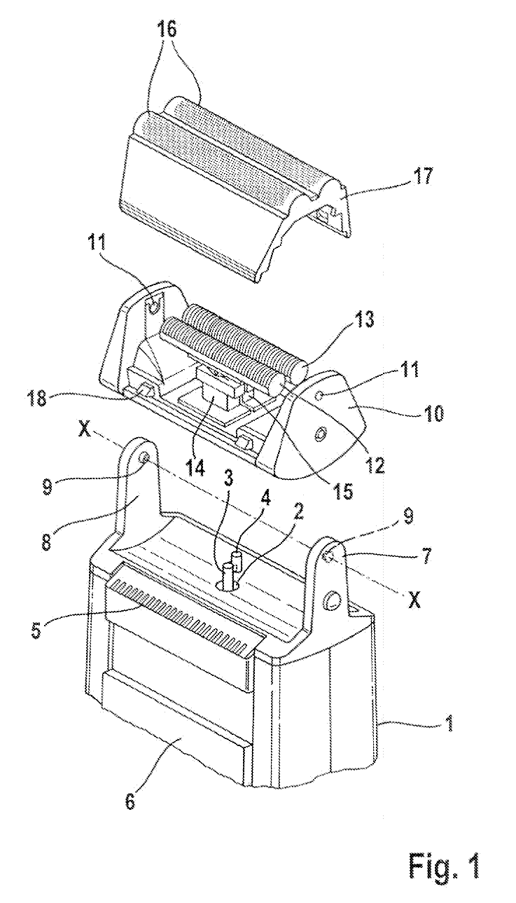

FIG. 1 shows a dry shaver with a housing 1 which in the region of its upper end has a cutout 2 through which a first and a second eccentric portion 3 and 4, respectively, of a drive shaft project. Said drive shaft is driven for rotary movement by an electric motor not shown in this representation.

Arranged on the front wide side of the housing is a trimmer 5 which can be displaced and switched on by means of a switch 6. The upper end also includes two arms 7 and 8 which are constructed as extensions of the narrow sides of the housing and have bearing points 9 for mounting the shaving head 10. For this purpose the shaving head 10 has corresponding bearings 11 which are arranged on its side cheeks. In the assembled state the shaving head 10 is mounted in the housing 1 such as to be pivotal about the axis X-X.

This pivoting capability ensures that the two cutting systems, which will be described later, of the shaving head 10 invariably engage the skin to be shaved at an optimal angle, and do so regardless of the angular position of the housing 1 relative to the skin.

The shaving head 10 mounts in its interior a first and a second under cutter 12 and 13 by means of associated oscillatory bridges, namely the first oscillatory bridge 14 and the second oscillatory bridge 15, for translational displacement in a direction parallel to the pivot axis X-X. Each under cutter 12, 13 includes a plurality of blades arranged one behind the other and in parallel alignment.

When the shaving head 10 is mounted on the housing 1 by means of the bearing points 9, the two eccentric portions 3 and 4 engage respectively in corresponding coupling portions of the associated oscillatory bridges 14 and 15, respectively. With the drive shaft rotating, the two under cutters 12, 13 are then moved in phase opposition to each other, performing a translational oscillatory movement. Assigned to each under cutter 12, 13 is a shaving foil 16 which is provided in an exchangeable frame 17. The latter has on its inner side corresponding recesses by means of which the exchangeable frame 17 can be securely coupled to the shaving head 10 in combination with catches 18 arranged on the shaving head 10.

The shaving foils 16 are constructed in arched shape, partly embrace the rounded blades of the under cutters 12, 13, and have a plurality of holes for penetration of the hairs to be cut. In connection with the oscillatory reciprocation of the under cutters 12, 13, the hairs which pass through the holes are cut off between the shaving foil and the corresponding blade of the under cutter.

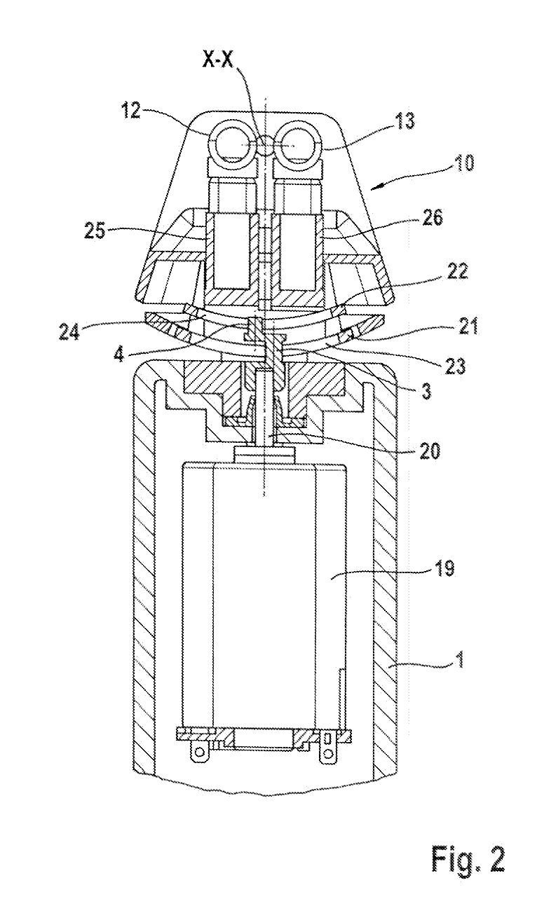

FIG. 2 shows a section perpendicular to the axis X-X, taken through the middle of a dry shaver. This representation shows the electric motor, which is arranged in the housing 1, and its drive shaft 20, which is driven in a rotary motion. The electric motor 19 is fixedly integrated in the housing 1 and can be actuated by an On/Off switch. Mounted on the drive shaft 20 in a non-rotating relationship and axially secured against displacement is a shaped part which has a first and a second eccentric portion 3 and 4, respectively. In this arrangement, said eccentric portions are arranged axially one behind the other and their eccentricities lie diametrically opposed, that is, they are turned through an angle of 180° relative to each other. The first eccentric portion 3 lies nearer to the electric motor 19, while the second eccentric portion lies close to the shaving head 10. The first eccentric portion 3 engages in the coupling portion 21 which is integrally formed on the first oscillatory bridge 14 and thus connects the first under cutter 12 to the electric motor 19. Integrally formed on the second oscillatory bridge 15 is likewise a coupling portion 22 which connects with the second eccentric portion 4 and hence with the electric motor 19.

The eccentricities of the two eccentric portions 3 and 4 equal 1.5 mm, approximately, so that during operation of the electric motor 19 the under cutters 12, 13 perform an oscillation in mutually opposite directions with an amplitude of 3 mm, approximately. Because the eccentric portions are arranged on the same drive shaft 20, the oscillations of the under cutters 12, 13 also have the same oscillation frequency. As long as the moved masses are equally large, oscillations will balance each other in full by the opposite directions of movement. It is also possible of course to construct a shaving head which has cutting systems of different size, which then leads to moved masses equally differing in size. To obtain full balance of the oscillation forces in this case, it is possible to adjust the drive system such that the eccentricities of the eccentric portions differ from each other. A smaller amplitude would then be imposed on the cutting system with the larger mass than on the lighter cutting system.

To receive the eccentric portion 3 the coupling portion 21 has a slot 23 extending in a direction transverse to the pivot axis X-X, while the coupling portion 22 has a similarly extending slot 24 in which the second eccentric portion 4 is received. The two coupling portions 21 and 22 are constructed to be arch-shaped in cross section and extend approximately concentrically to the pivot axis X-X. As the result, during the pivot movement about the axis X-X the coupling portions are moved solely on their respectively assigned radii. The relative axial distances of the eccentric portions 3, 4 can be selected very small therefore. Similarly, the coupling portions 21, 22 can also be constructed to lie close together. Consequently the eccentric portions 3, 4 also need to have only a small axial dimension because, contrary to a construction of the coupling portions with a rectilinear cross section, there occurs no tilting of the coupling elements relative to the drive shaft in dependence upon the angle of pivot about the axis X-X. The length of the slots 23 and 24 is coordinated with the maximum pivot angle of the shaving head 10. In vertical direction the slots 23 and 24 are constructed as through slots; at least the slot 23 must be constructed as a through hole to enable the second eccentric portion 3 to be passed through it. The slot 24 can also be constructed as a slot-shaped groove which does not extend throughout. Each of the two oscillatory bridges 14, 15 carries a mounting well 25 and 26, respectively, in which the under cutters 12 and 13, respectively, can be mounted in known manner by means of suitable axles or pins. Seated between the mounting wells 25, 26 and their associated under cutters 12 and 13, respectively, are spring elements which bias the under cutters in the direction of the shaving foils 16. Full surface contact between the under cutters and the associated shaving foils is thus assured at all times.

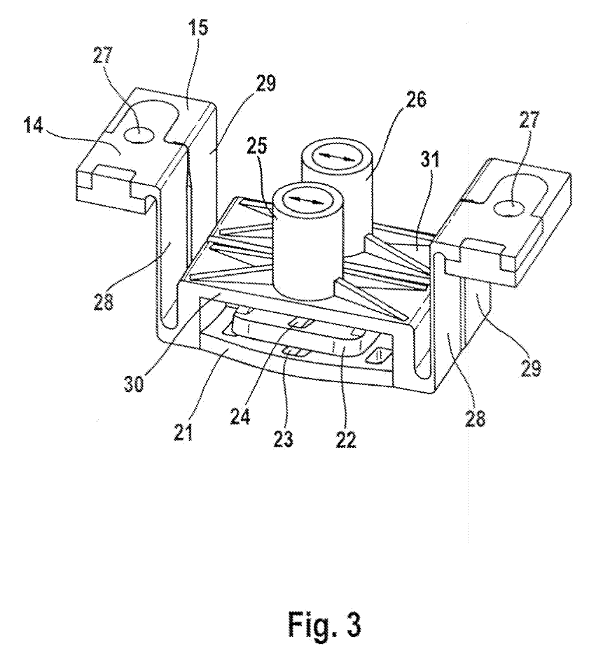

FIG. 3 shows an oscillatory bridge arrangement according to FIG. 2 with the first oscillatory bridge 14 and the second oscillatory bridge 15. This Figure shows clearly how the two coupling portions 21 and 22 are nested together and cover, at least perpendicular to the oscillation direction (double arrow), the region underneath both oscillatory bridges.

In the region of the fastening points 27 by means of which the oscillatory bridges are fastened in the shaving head 10, said bridges are dovetailed so that as the result of this positive engagement they can be fixed in the shaving head 10 with a single shared fastening screw. Extending vertically downwards from this fastening zone are a total of four leaf-shaped portions 28, 29, with the portions 28 of the first oscillatory bridge 14 lying on the left and right alongside the carrier 30 of said oscillatory bridge and connecting said carrier elastically to the fastening zone. The same applies to the second oscillatory bridge 15 and its leaf-shaped portions 29, which are associated with the carrier 31. To enable the coupling portion 22 to also perform oscillating movements in its mounting space, provision is made for adequate clearance between this portion and all the parts of the first oscillatory bridge 14.

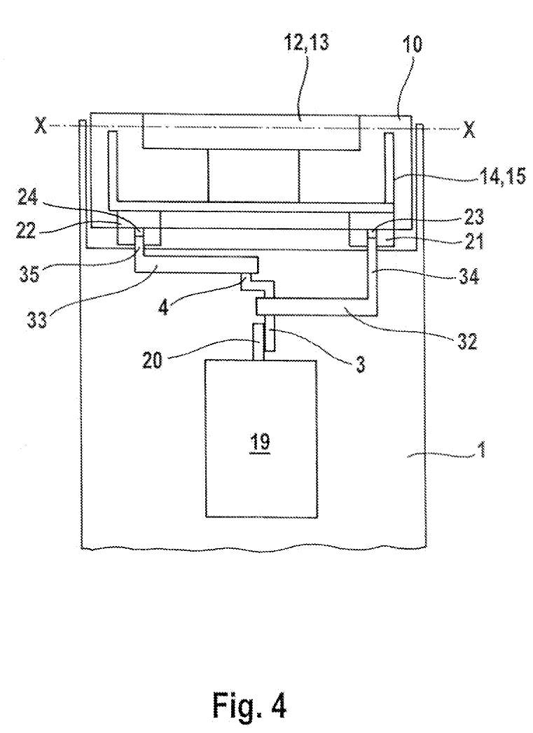

FIG. 4 shows an embodiment in which the coupling portions 21, 22 of the oscillatory bridges 14, 15 are not nested together but arranged side by side. In this example, too, an electric motor 19 with a drive shaft 20 is arranged in the housing 1 of the shaving apparatus, with the drive shaft 20 mounting two eccentric portions 3 and 4. Mounted on each of the eccentric portions 3, 4 is a connecting rod 32 and 33, respectively, whose pin 34 and 35, respectively, connects with associated coupling portions 21 and 22, respectively, of the oscillatory bridges 14 and 15, respectively. The pins 34 and 35 are mounted for displacement within groove-shaped slots 23 and 24, respectively, said slots 23 and 24 extending, as in the preceding Figures, in the associated coupling portions 21 and 22, respectively, in a direction transverse to the pivot axis X-X of the shaving head 10. The oscillatory bridges 14 and 15 lie one behind the other in the plane of projection, each carrying one of the under cutters 12 and 13, respectively. When the drive shaft 20 rotates, the linear oscillation parallel to the pivot axis X-X is transferred via the connecting rods 32, 33 to the oscillatory bridges. Because—as in the preceding example—the eccentric portions 3, 4 are turned relative to each other through an angle of 180°, the oscillatory bridges 14, 15 oscillate in mutually opposite directions. Due to the arrangement of the slots 23, 24 in a direction transverse to the pivot axis X-X and the displaceable mounting of the pins 34, 35 within said slots, the shaving head 10 can be pivoted while the driving connection between the electric motor 19 and the oscillatory bridges 14, 15 is maintained.

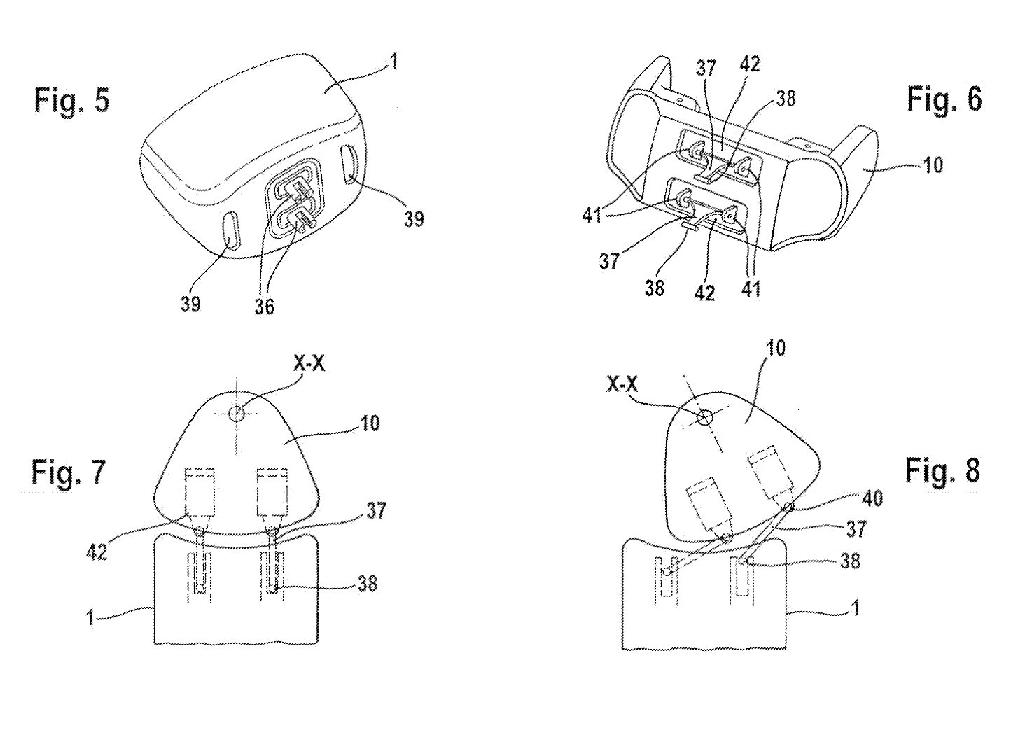

FIGS. 5 to 8 show an embodiment in which two drive elements performing oscillatory motions in mutually opposite directions project from the housing 1. The drive elements involved are two pin-shaped oscillators 36 extending in a sealed relationship out of the housing and having recesses for pivotally receiving the lower ends 38 of respective joint pushrods 37. In this arrangement, the mounting of the joint pushrods in the oscillators is pivotal as well as linearly displaceable.

In FIGS. 5 and 6, the housing of the dry shaver and the shaving head 10 are shown separated from each other, and the representation of a holding yoke for the pivotal mounting of the shaving head 10 is dispensed with. The yoke is passed out of the housing 1 through the openings 39 and includes bearing points which cooperate in a manner known in the art with corresponding bearing points of the shaving head.

FIG. 7 shows a side view in which the shaving head 10 is in a mid-position, while FIG. 8 shows the pivot position of the shaving head 10 as swung out relative to the housing 1.

Each of the two joint pushrods 37 has its upper end 40 pivotally connected via corresponding eyelets 41 to a respective oscillatory plate 42. This connection enables the joint pushrod 37 to be pivotal about an axis extending parallel to the pivot axis X-X. It lies moreover parallel to the oscillation direction of the oscillators and to the respective oscillatory plates 42 connected to them. On account of this connection the oscillatory plates 42 are driven to perform oscillatory linear motions in mutually opposite directions. The plates contain arrangements, not shown in greater detail, for mounting the under cutters. The pivotability of the joint pushrods within their bearings and the linear displaceability of the lower end 38 within the oscillators 36 is coordinated such that this driving connection is able to follow the maximum pivotability of the shaving head 10 relative to the housing 1 about the pivot axis X-X.

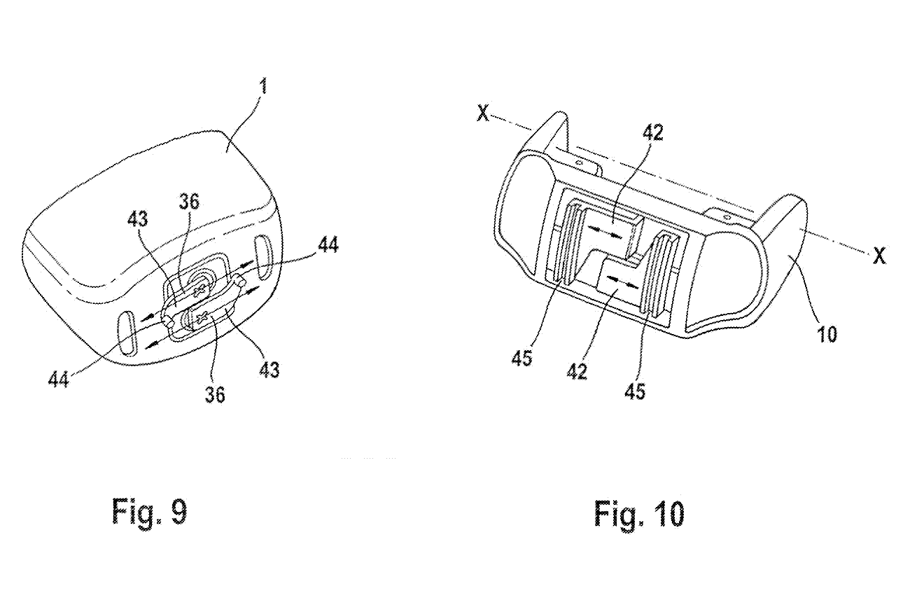

Another embodiment is shown in FIGS. 9 and 10 which, like the representation in FIGS. 5 and 6, show a housing 1 with a shaving head 10 detached therefrom. Projecting out of the housing 1 in this embodiment are two oscillators 36 which lie side by side adjacent to each other and are driven to perform oscillatory linear motions in mutually opposite directions. The oscillators 36 have plate-shaped portions 43 which carry pin elements 44 on an inwardly bent region. These pin elements 44 are arranged so far inside that they move on a common straight line during oscillating operation of the oscillators 36. As in the preceding embodiment the shaving head 10 is connected via a yoke element, not shown, to the housing 1 such as to be pivotal about the axis X-X. In the mounted state of the shaving head, 10 the pin elements 44 engage within a respective associated transverse groove 45 which is formed on a respective oscillatory plate 42 and extends in a direction transverse to the pivot axis X-X. The two oscillatory plates 42 are mounted in the shaving head 10 for displacement parallel to the pivot axis X-X and lie parallel to each other. Each transverse groove 45 extends in arched shape about the pivot axis X-X. In addition, each transverse groove 45 is arranged in a portion of its oscillatory plate 42 which overlaps the adjacent oscillatory plate at least in part. These portions are nested in each other like stair steps. The two oscillatory plates can be mounted for displacement within each other by means of suitable arrangements, for example, a tongue-and-groove connection or a dovetail connection. The double arrows in the FIGS. 9 and 10 indicate the direction of the oscillation movement of the components concerned, with the two oscillators 36 and hence also the oscillatory plates 42 carrying a respective under cutter being driven in mutually opposite directions.

What is claimed is:

1. A dry shaver comprising:
a housing;
a drive motor arranged in the housing
a driver coupled to the drive motor;
a shaving head configured to be coupled to the housing and pivotable about an axis defined by the housing, the shaving head comprising at least two shaving systems, each shaving system comprising:
an outer cutter;
an oscillator configured to be coupled to the driver, and
an under cutter coupled to the oscillator and drivable in an oscillatory linear motion relative to the outer cutter, wherein the under cutter of a first one of the shaving systems is drivable in a mutually opposite direction from the under cutter of a second one of the shaving systems.

2. The dry shaver according to claim 1, further comprising an additional driver coupled to the drive motor, wherein each of the drivers is configured to be coupled to one of the oscillators, and the drivers are drivable in a translational oscillatory movement.

3. The dry shaver according to claim 1, wherein the drive motor comprises a rotationally driven drive shaft coupled to the driver, and the driver comprises at least two spaced-apart eccentric portions arranged on opposite sides of the axis defined by the housing.

4. The dry shaver according to claim 1, wherein the driver is configured to directly engage one of the oscillators.

5. The dry shaver according to claim 1, wherein the driver is configured to indirectly engage one of the oscillators.

6. The dry shaver according to claim 5, wherein the driver is configured to engage one of the oscillators via a connecting rod.

7. The dry shaver according to claim 5, wherein the driver is configured to engage one of the oscillators via a joint pushrod.

8. The dry shaver according to claim 1, further comprising an additional driver coupled to the drive motor, wherein each of the oscillators defines a slot extending in a direction transverse to a pivot axis of the shaving head, and each oscillator is configured to be coupled to one of the drivers via the slot.

9. The dry shaver according to claim 8, wherein at least one of the slots is a through-slot.

10. The dry shaver according to claim 1, wherein one of the oscillators is configured to be coupled to another one of the oscillators.

11. The dry shaver according to claim 1, wherein the oscillators are driven with different amplitudes.

12. The dry shaver according to claim 1, further comprising an additional driver coupled to the drive motor, wherein each oscillator comprises a coupler, the oscillators are configured to be coupled to the drivers via the couplers, and the couplers are arranged concentrically with respect to a pivot axis of the shaving head.
